(19) United States
(12) Patent Application Publication
(10) Pub. No.: US 2014/0054312 A1
(43) Pub. Date: Feb. 27, 2014

(54) GOODS DELIVERY MECHANISM FOR VENDING MACHINE

(71) Applicants: HON HAI PRECISION INDUSTRY CO., LTD., New Taipei (TW); HONG FU JIN PRECISION INDUSTRY (Wu-Han) CO., LTD., Wuhan (CN)

(72) Inventors: YUN-LUNG CHEN, New Taipei (TW); CHUNG CHAI, New Taipei (TW); DA-LONG SUN, Wuhan (CN); SHENG-HE LI, Wuhan (CN)

(73) Assignees: HON HAI PRECISION INDUSTRY CO., LTD., New Taipei (TW); HONG FU JIN PRECISION INDUSTRY (WUHAN) CO., LTD., Wuhan (CN)

(21) Appl. No.: 13/901,956

(22) Filed: May 24, 2013

(30) Foreign Application Priority Data
Aug. 22, 2012 (CN) 2012102999675

(51) Int. Cl. G07F 11/42

(52) U.S. Cl. CPC G07F 11/42
USPC 221/258

(57) ABSTRACT

A goods delivery assembly for a vending machine includes a motor, a shaft, a first gear, a second gear, and a coil to hold goods. Peripheral teeth and a shallow ball joint between the two gears enables the second gear to continue to be rotated by the first driving gear at angles which are not coaxial with the first gear, to achieve adjustability of the mounting angle of the coil for holding different goods.

### BACKGROUND

1. Technical Field

The present disclosure relates to goods delivery mechanisms, and particularly to a goods delivery mechanism in an automatic vending machine.

2. Description of Related Art

In an automatic vending machine, a delivery assembly is used for pushing goods out of a goods channel. The delivery assembly includes a large helical coil and a motor. The goods are placed on the coil. The motor rotates the coil to move the goods out of the goods channel. In known vending machines, the coil can accommodate only one item of goods because a mounting angle of the coil is not adjustable.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is exploded, isometric view of an embodiment of a goods delivery assembly.

FIG. 2 is similar to FIG. 1, but viewed from another aspect.

FIG. 3 is an enlarged view of an encircled portion III of FIG. 1.

FIG. 4 is an assembled view of the goods delivery assembly of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

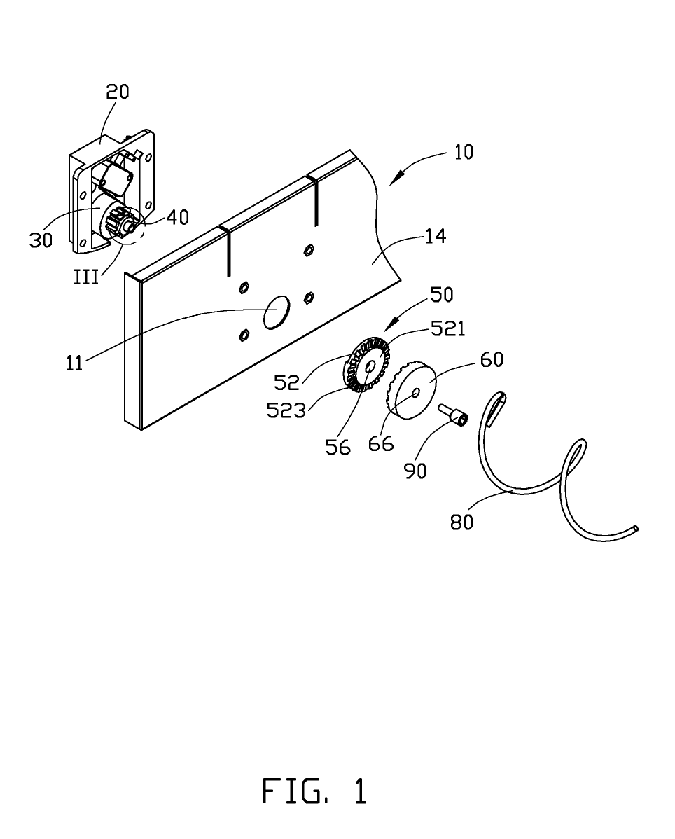

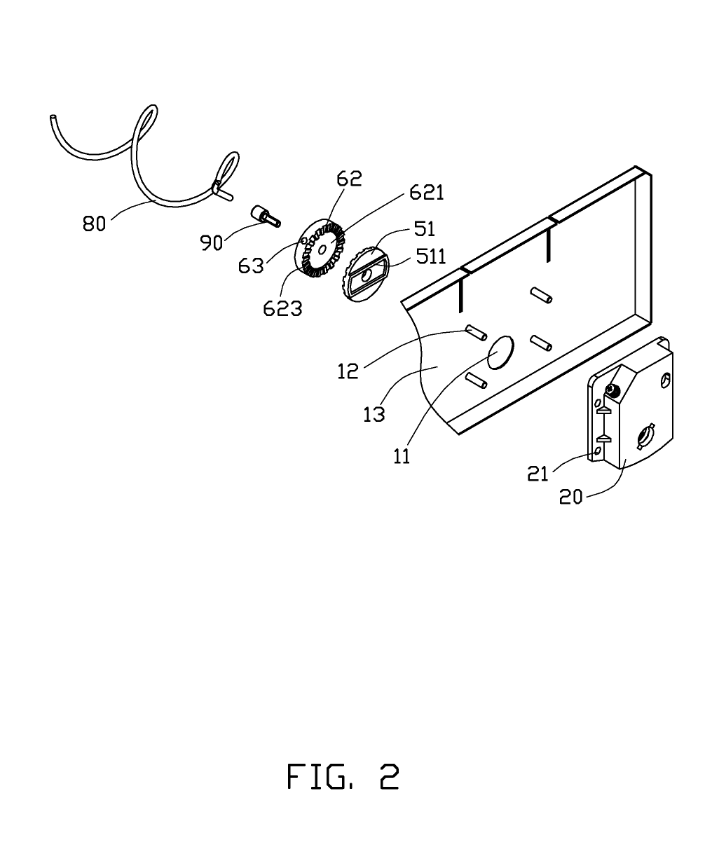

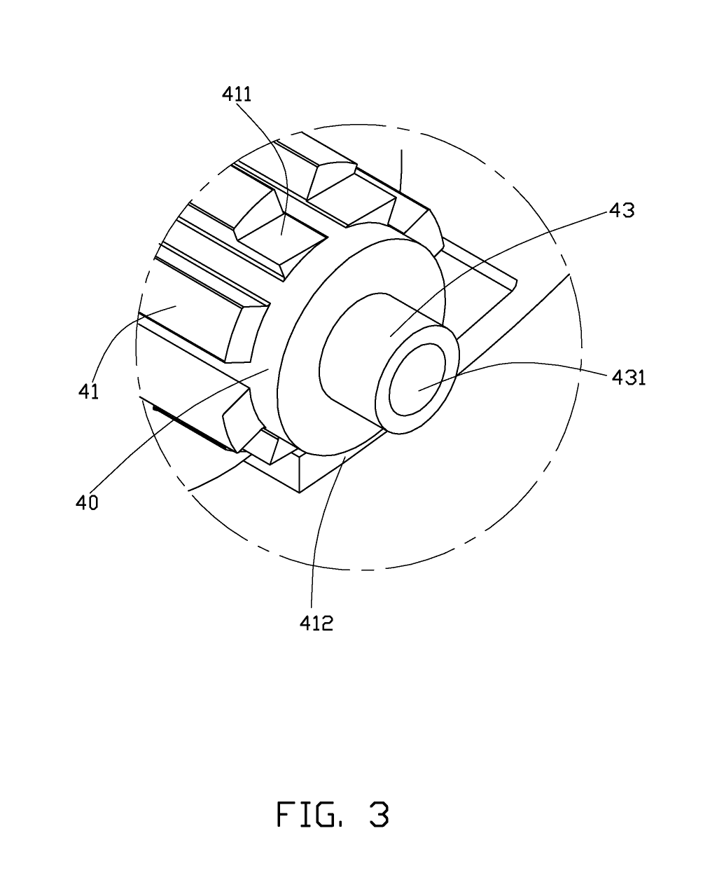

Referring to FIGS. 1 to 3, an embodiment of a goods delivery assembly for a vending machine includes a plate 10, a casing 20, a motor 30, a splined driving shaft 40 driven by the motor 30, a first gear 50, a second gear 60, and a coil 80 for receiving goods thereon.

The plate 10 defines a through hole 11 extending through the plate 10. The plate 10 includes an outer side 13 and an inner side 14. Four fixing pins 12 are located on the outer side 13 and around the through hole 11.

The motor 30 is mounted in the casing 20. The casing 20 defines four fixing holes 21 corresponding to the four fixing pins 12 of the plate 10.

The splined driving shaft 40 is rotated by the motor 30. A plurality of splines 41 is located on periphery of the shaft 40. A flat is machined across the distal end of two top splines 41 to form a first engaging cutout 411. A similar and opposing flat is machined across the distal end of two bottom splines 41 to form a second engaging cutout 412. A connecting post 43 protrudes from an end of the shaft 40. The connecting post 43 is hollow to define a securing hole 431. A diameter of the shaft 40 is smaller than a diameter of the through hole 11.

The first gear 50 includes a fixing side 51 facing the plate 10 and a first engaging side 52 facing the second gear 60. A center portion of first gear 50 defines a first connecting hole 56 corresponding to the connecting post 43. Two bars 511 are formed on the fixing side 51. A rounded swelling 521) protrudes from the first engaging side 52. A plurality of teeth 523 is formed on the first engaging side 52 to surround and frame the rounded swelling 521.

The second gear 60 includes a second engaging side 62 facing to the first engaging side 52 of the first gear 50. The second gear 60 defines a second connecting hole 66 corresponding to the connecting post 43. The second engaging side 62 defines a rounded depression 621 ( ) corresponding in shape to the rounded swelling 521 of the first gear 50. A plurality of second teeth 623 is formed on the second engaging side 62 to surround and frame the rounded depression 621. A radial mounting hole 63 is defined on periphery of the second gear 60. An extending direction of the mounting hole 63 is perpendicular to an extending direction of the second connecting hole 66. The mounting hole 63 and the connecting hole 66 are not interconnected.

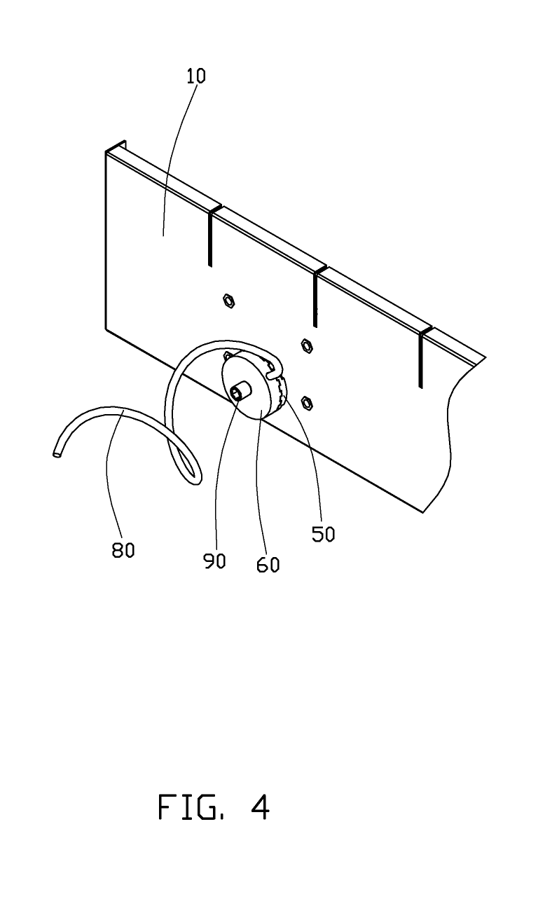

Referring to FIGS. 1 to 4, in assembly, the four fixing pins 12 of the plate 10 are inserted in the four fixing holes 21 of the casing 20 to mount the casing 20 on the inner side 13 of the plate 13. The shaft 40 is inserted in the through hole 11 to protrude in the inner side 14.

The first gear 50 is moved towards the shaft 40 with the first engaging side 52 facing the shaft 40. The connecting post 411 of the shaft 40 is inserted in the first connecting hole 56 of the first gear 60, and the two bars 511 of the first gear 50 slide over and engage the first engaging cutout 411 and the second engaging cutout 412, to lock the first gear 50 on the shaft 40. The first gear 50 is then rotatable together with the shaft 40.

The second gear 60 is moved towards the first gear 50 with the second engaging side 62 facing the first engaging side 52. The connecting post 411 of the shaft 40 is inserted in the second connecting hole 66 of the second gear 60. The rounded swelling 521 of the first gear 50 engages with the rounded depression 621 of the second gear 60.

The second teeth 623 of the second gear 60 are engaged in the first teeth 523 of the first gear 50. The second gear 60 is thus rotatable by the first gear 50. A securing stick 90 is inserted in the securing hole 431 of the connecting post 43 to mount the first gear 50 and the second gear 60 on the shaft 40. Finally, one end of the coil 80 is inserted in the mounting hole 63 to mount the coil 80 on the second gear 60. The goods delivery assembly is thereby assembled completely.

When a mounting angle of the coil 80 needs to be adjusted, the securing stick 90 is detached from the securing hole 431. The second teeth 623 of the second gear 60 can engage in the first teeth 523 of the first gear 50 at other angles as the rounded swelling 521 rides within the rounded depression 621 substantially in the manner of a ball joint. Therefore, the mounting angle of the coil 80 is adjustable.

It is to be understood, however, that even though numerous characteristics and advantages of the embodiments have been set forth in the foregoing description, together with details of the structure and functions of the embodiments, the disclosure is illustrative only, and changes may be made in detail, especially in the matters of shape, size, and arrangement of parts within the principles of the present disclosure to the full extent indicated by the broad general meaning of the terms in which the appended claims are expressed.

What is claimed is:

1. A goods delivery assembly, comprising:
a motor comprising a rotatable shaft;
a first gear fixed on the shaft and rotatable together with the shaft;
a second gear adjustably engaged with the first gear, the second gear being rotatable together with the shaft; and
a coil mounted on the second gear at a mounting angle; wherein the mounting angle is adjustable by adjusting the second gear with respect to the first gear.

2. The goods delivery assembly of claim 1, wherein a plurality of splines is located on a periphery of the shaft, the plurality of splines defines a first engaging cutout and a second engaging cutout, the first gear comprises a fixing side, two bars are located on the fixing side, and the first gear is fixed on the shaft by engaging each of the two bars into each of the first and the second engaging cutouts.

3. The goods delivery assembly of claim 2, wherein a connecting post is connected on an end of the shaft, the first gear defines a first connecting hole, and the connecting post is inserted into the first connecting hole.

4. The goods delivery assembly of claim 3, wherein the second gear defines a second connecting hole, and the connecting post is inserted in the second connecting hole.

5. The goods delivery assembly of claim 4, wherein the connecting post is hollowed to define a securing hole, and a securing stick is inserted into the securing hole.

6. The goods delivery assembly of claim 4, wherein a mounting hole is defined on a periphery of the second gear, and an end of the coil is inserted into the mounting hole.

7. The goods delivery assembly of claim 6, wherein an extending direction of the mounting hole is perpendicular to an extending direction of the second connecting hole, and the mounting hole and the connecting hole are not crossed in the second gear.

8. The goods delivery assembly of claim 1, wherein the first gear comprises a first engaging side facing to the second gear, a plurality of first teeth is located on the first engaging side, the second gear comprises a second engaging side facing to the first engaging side of the first gear, a plurality of second teeth is located on the second engaging side, and the plurality of first teeth is engaged with the plurality of second teeth.

9. The goods delivery assembly of claim 8, wherein the first engaging side comprises a rounded swelling, and the second engaging side defines a rounded depression, and the rounded swelling is received in the rounded depression.

10. The goods delivery assembly of claim 9, wherein the plurality of first teeth surrounds the rounded swelling, and the plurality of second teeth surrounds the rounded depression.

11. A goods delivery assembly, comprising:
a rotatable shaft;
a first gear fixed on the shaft, the first gear comprising a first engaging side, and a plurality of first teeth formed on the first engaging side; and
a second gear comprising a coil mounted thereon, the second gear comprising a second engaging side facing to the first engaging side of the first gear, and a plurality of second teeth formed on the second engaging side; wherein the plurality of second teeth is configured to engage with the plurality of first teeth in different angles and to adjust a mounting angle of the coil.

12. The goods delivery assembly of claim 11, wherein a plurality of splines is located on a periphery of the shaft, the plurality of splines defines a first engaging cutout and a second engaging cutout, the first gear comprises a fixing side, two bars are located on the fixing side, and each of the two bars are engaged in each of the first and the second engaging cutouts to fix the first gear on the shaft.

13. The goods delivery assembly of claim 12, wherein a connecting post is connected on an end of the shaft, the first gear defines a first connecting hole, and the connecting post is inserted into the first connecting hole.

14. The goods delivery assembly of claim 13, wherein second gear defines a second connecting hole, and the connecting post is inserted into the second connecting hole.

15. The goods delivery assembly of claim 14, wherein the connecting post is hollowed to define a securing hole, and a securing stick is inserted into the securing hole.

16. The goods delivery assembly of claim 14, wherein a mounting hole is defined on a periphery of the second gear, and an end of the coil is inserted into the mounting hole.

17. The goods delivery assembly of claim 16, wherein an extending direction of the mounting hole is perpendicular to an extending direction of the second connecting hole, and the mounting hole and the connecting hole are not crossed in the second gear.

18. The goods delivery assembly of claim 11, wherein the first engaging side comprises a rounded swelling, and the second engaging side defines a rounded depression, and the rounded swelling is received in the rounded depression.

19. The goods delivery assembly of claim 18, wherein the plurality of first teeth surrounds the rounded swelling, and the plurality of second teeth surrounds the rounded depression.
